(19) United States
(12) Patent Application Publication
(10) Pub. No.: US 2002/0075233 A1
(43) Pub. Date: Jun. 20, 2002

(54) Ergonomic pointing device

(76) Inventors: Christopher Daniel White, Reisterstown, MD (US); Benjamin David Krasnow, Redwood City, CA (US)

Correspondence Address: VENABLE, Post Office Box 34385, Washington, DC, 20043-9998, US

(21) Appl. No.: 09/739,845

(22) Filed: Dec. 20, 2000

(51) Int. Cl. G09G 5/08

(52) U.S. Cl. 345/161

(57) ABSTRACT

An ergonomic pointing device can include a grip portion configured for handheld use, a finger-stick coupled to the grip portion, operative to control a cursor pointer, and a first button disposed on the grip portion operative to receive a user selection. The pointing device can include a finger-stick with a thimble-shaped housing. The finger-stick can include a first member axially intersecting a rotable sphere, the first member coupled at one end symmetrically to an inverted U-shaped clevis member and at another end to the grip, and wherein the U-shaped clevis can rotate about an axis intersection the end points of the U-shaped clevis. The finger-stick can include a vertical member, a pivot, and a horizontal member coupled at an inner point to the pivot, and including controls at the ends of the horizontal member. An apparatus operative to receive a rechargeable wireless pointing device can include a base operative to recharge a rechargeable power supply of the pointing device, a second wireless transceiver coupled to the base in wireless communication with a first wireless transceiver of the pointing device, a power supply coupled the base, and an interface coupled to the base.

### BACKGROUND OF THE INVENTION

1. Field of the Invention

The present invention relates generally to cursor pointing devices and more particularly to handheld pointing devices.

2. Related Art

Various cursor pointing and positioning apparatuses have been proposed and implemented to effect the movement of a cursor on a computer display or other screen. The most common variant, known as a mouse, has a small hand held housing having one or more sensing rollers on the underside. The mouse produces digital pulses as a function of movement of the housing in an X or Y direction on a surface. Usually, the mouse is moved over a resilient surface which enables the rollers to engage frictionally. This frictional engagement requires dragging the mouse across the flat surface, usually a desktop or mouse pad. Conventional apparatuses are significantly limited in that they require a user to physically move his or her entire arm in relatively the same magnitude and direction as they intend to move the cursor on the screen. Use of such prior devices frequently leads to shoulder and arm fatigue, serious discomfort and possibly carpal tunnel syndrome due to the constant arm motion.

Efforts have been made to provide improved cursor pointing devices including, for example, Microsoft Mouse™ with scroll wheel available from Microsoft Corporation of Redmond, Wash., U.S.A.; and the IBM Trackpoint II™ pointing device available from IBM Corporation of Armonk, N.Y., U.S.A. Although a large variety of cursor and related positioning apparatuses have been developed, such significant problems and limitations with prior apparatus limit their application and user performance. Conventional solutions have shortcomings and share the common limitations of lack of device sensitivity, difficulty in maintaining cursor control, and discomfort and injury due to the constant stresses on, e.g., the user's shoulders, arms, wrist and hands.

Thus, what is needed is an improved pointing device that overcomes the shortcomings of conventional computer mice and other pointing devices.

### SUMMARY OF THE INVENTION

The present invention is directed to a pointing device.

In an exemplary embodiment, the pointing device can include a grip portion configured to handheld use, a finger-stick coupled to the grip portion operative to control a cursor pointer, and a first button disposed on the grip portion operative to receive a user selection.

In an exemplary embodiment, the pointing device can further include a first wireless transceiver coupled to the grip portion and a rechargeable power supply coupled to the grip portion.

In an exemplary embodiment, the finger-stick can be operative as a joystick.

In an exemplary embodiment, the first wireless transceiver can include a radio frequency RF wireless transceiver, an infrared IR wireless transceiver, a laser transceiver, and a microwave transceiver.

In an exemplary embodiment, the device can be operative to control the cursor of a computing device, a gaming device, an Internet appliance, a projector, audio/visual equipment, a virtual reality software application, a software application game, and a television.

In an exemplary embodiment, the device can include a second button operative for use selection by the ring and pinky fingers of the user.

In an exemplary embodiment, the device can include a clamp configured to receive the device configured to attach to a chair, office furniture, a stationary object, furniture, and home furniture.

In an exemplary embodiment, the device can include a scroll wheel disposed on the grip portion.

In an exemplary embodiment, the scroll wheel can be used to page up and page down through a displayed screen of text.

In an exemplary embodiment, the scroll wheel can be operative to control the cursor pointer and to manipulate, in a z-direction, 3D applications.

In an exemplary embodiment, the device can include an orientation sensor operative to determine an orientation of the pointing device.

In an exemplary embodiment, the orientation sensor can include a sphere having a core substantially filled with liquid, an air pocket, and spherically arranged sensors operative to determine a location of the air pocket to determine orientation.

In an exemplary embodiment, the device can include a base operative to recharge the rechargeable power supply, a second wireless transceiver coupled to the base in wireless communication with the first wireless transceiver, a power supply coupled to the base, and an interface coupled to the base.

In an exemplary embodiment, the interface can include a serial interface, an RS/232 asynchronous interface, a PS/2 mouse interface, a PC/AT mouse interface, a universal serial bus USB interface, a USB2 interface, and a firewire interface.

In an exemplary embodiment, the device can include an interface coupled to the grip portion.

In an exemplary embodiment, the interface coupled to the grip can include a serial interface, an RS/232 asynchronous interface, a PS/2 mouse interface, a PC/AT mouse interface, a universal serial bus USB interface, a USB2 interface, and a firewire interface.

In an exemplary embodiment, the device can include a computer system coupled to the base by an interface.

In an exemplary embodiment, the finger-stick can include a finger-stick control module including a quad matrix of variable resistors, wherein each variable resistor of the quad matrix of variable resistors varies in conductivity directly in proportion with a static position of the fingerstick control, wherein the first two of the quad matrix of variable resistors are provided for an x-axis of motion to account for positive and negative movement, and wherein the second two of the quad matrix variable resistors are provided for a y-axis of motion to account for positive and negative movement.

In an exemplary embodiment, each variable resistor of the quad matrix of variable resistors can include an interlocking grid of conductor traces over which a rubber carbon compound can be placed wherein increased pressure on the rubber compound increase circuit conductivity.

In an exemplary embodiment, the device can include an analog to digital converter coupled to the first and second buttons and the finger-stick and is operative to translate directional movement and receiver selections of the first and second buttons into digital code.

In an exemplary embodiment, the device can include a central processing unit CPU coupled to the analog to digital converter ADC and operative to organize and add protocol to the digital code.

In an exemplary embodiment, the finger-stick can include a thimble-shaped housing.

In an exemplary embodiment, an apparatus to receive a rechargeable wireless pointing device can include a base operative to recharge a rechargeable power supply of the pointing device, a second wireless transceiver coupled to the base in wireless communication with a first wireless transceiver of the pointing device, a power supply coupled to the base, and an interface coupled to the base.

In an exemplary embodiment, the finger-stick can include a first member axially intersecting a rotable sphere, the first member coupled at one end symmetrically to an inverted U-shaped clevis member, and at another end to the grip, and wherein the U-shaped clevis member can rotate about an axis intersecting end points of the U-shaped clevis.

In an exemplary embodiment, the finger-stick can include a vertical member, a pivot, and a horizontal member coupled at an inner point to the pivot and including controls at the end of the horizontal member.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digits in the corresponding reference number.

### BRIEF DESCRIPTION OF THE DRAWINGS

The foregoing and other features and advantages of the invention will be apparent from the following, more particular description of a preferred embodiment of the invention, as illustrated in the accompanying drawings.

FIG. 1A depicts an exemplary embodiment of an ergonomic pointing device according to the present invention.

FIG. 1B depicts an exemplary embodiment of components of the ergonomic pointing device according to the present invention.

FIG. 1C depicts the exemplary device of FIG. 1A engaged by a user.

FIG. 2 depicts another exemplary embodiment of the ergonomic pointing device configured to be attached to a chair in accordance with the present invention.

FIG. 3A depicts another exemplary embodiment of the ergonomic pointing device including a desk mount base according to the present invention.

FIG. 3B depicts an exemplary embodiment of components of base computer according to the present invention.

FIG. 4 depicts a three-dimensional 3D position finder that can be used in one exemplary embodiment of the ergonomic pointing device according to the present invention.

FIG. 5A depicts another exemplary embodiment of the ergonomic pointing device including a control stick according to the present invention.

FIG. 5B depicts an enlarged view of an exemplary embodiment of the control stick according to the present invention.

FIG. 6A depicts a side view of an exemplary embodiment of the ergonomic pointing device including a clevis and ball according to the present invention.

FIG. 6B is a rear view of the exemplary embodiment depicted in FIG. 6A according to the present invention.

FIG. 6C is an enlarged view of an exemplary embodiment of the clevis and ball apparatus of the present invention.

### DETAILED DESCRIPTION OF THE INVENTION

A preferred embodiment of the invention is discussed in detail below. While specific implementations are discussed, it should be understood that this is done for illustration purposes only. A person skilled in the relevant art will recognize that other components and configurations may be used without parting from the spirit and scope of the invention.

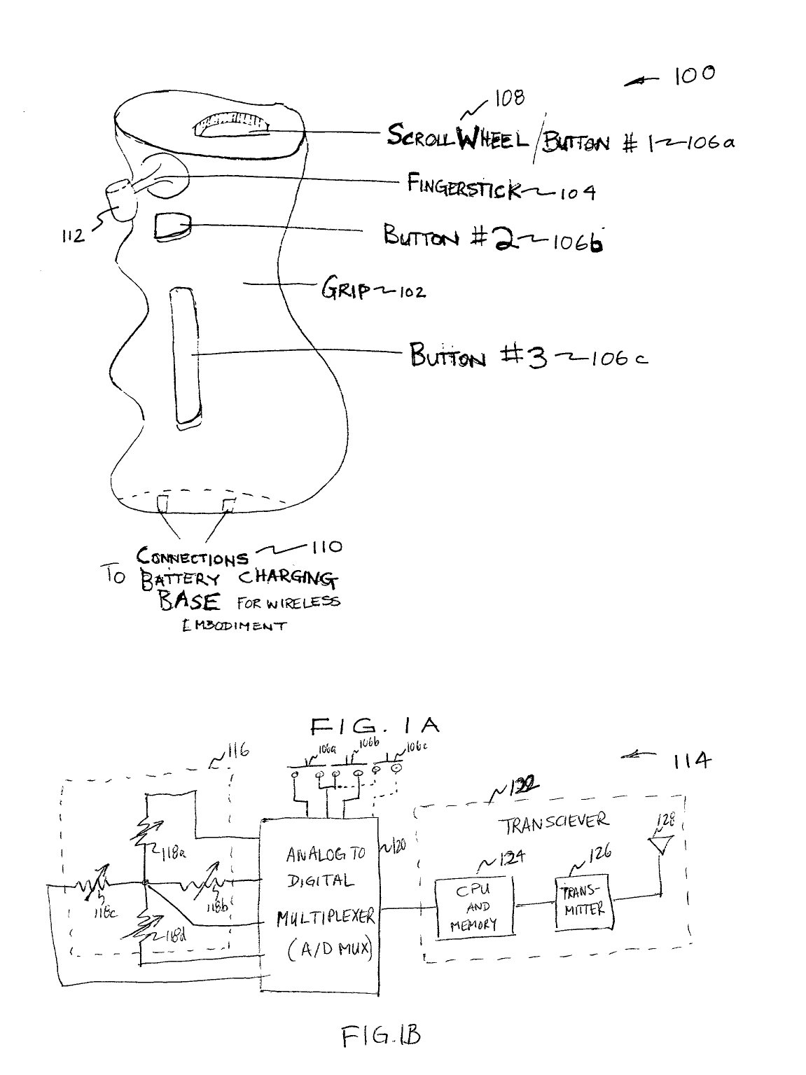

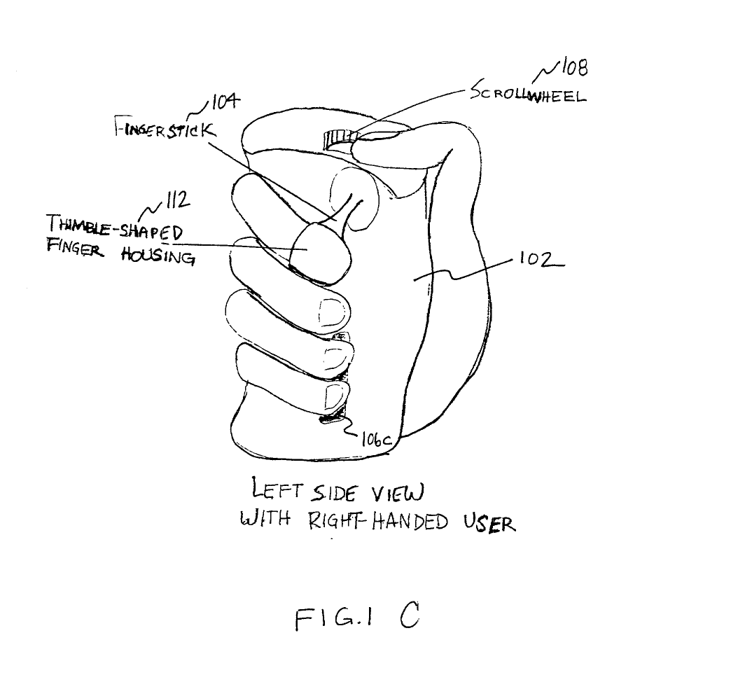

Referring now to the drawings, and more particularly to FIG. 1A, there is depicted an exemplary embodiment of an ergonomic pointing device 100. The device includes a grip 102 configured for handheld use.

The grip 102 in an exemplary embodiment can include a finger-stick 104 extending outward from the grip 102. The finger-stick 104 can further include a thimble-shaped housing 112 on one end of the finger-stick 104 configured to fit a finger or thumb such as, e.g., an index finger of a user. The thimble-shaped housing 112 can allow for optimal control of the fingerstick 104 for movement in any direction. The finger-stick 104 can be manipulated, e.g., along the x and y dimensions to move a cursor. In an exemplary embodiment, the more pressure that is applied to the finger-stick 104, the faster the cursor can move across the screen. Since the cursor can be controlled with just one finger, the amount of arm and muscle movement involved in typical mouse devices can be eliminated.

FIG. 1B depicts an exemplary embodiment of components of the ergonomic pointing device 100 including a control module 114. The pointing device 100 can include finger stick 104 with a finger stick control module 114. The finger-stick control module 114 can include, e.g., a quad matrix 116 of variable resistors 118a-118d. Each variable resistor 118a-d of the quad matrix 116 can vary in conductivity directly in proportion with the static position of the fingerstick 104. The first two variable resistors 118a and 118b of the quad matrix 116 can detect an x-axis of motion to account for both positive and negative movement. The second two variable resistors 118c and 118d of the quad matrix 116 can detect a y-axis of motion to account for both positive and negative movement. The control module 114 can also include an analog to digital multiplexer (A/D Mux) 120 coupling the quad matrix 116 to a transceiver 122 and mouse buttons 106a-c. The transceiver 122 can include e.g., a CPM and memory 124, a transmitter 126, and an antenna 128.

Additionally, each variable resistor 118a-d of the quad matrix 116 of variable resistors may include an interlocking grid of conductor traces over which a rubber carbon compound can be placed. Increased pressure on the rubber compound can increase circuit conductivity.

In an exemplary embodiment, a first button 106a can be located on the top panel of the grip 102. The first button 106a can be activated by the thumb or other finger of the user. Alternatively, the first button 106a can include a scroll wheel 108 which can be used, e.g., in scrolling a cursor up or down a computer screen or to more a graphical user interface (GUI) scroll bar within computer applications. The scroll wheel 108 can be rotated about an axis for scrolling or can be depressed to engage the first button 106a function. In an alternative embodiment, the scroll wheel 108 can be configured to manipulate a cursor in a z-direction for 3-D applications. A second button 106b can be located on the side of the grip 102 where a middle finger can comfortably operate it. It will be apparent to those skilled in the art that right-handed version or a left-handed version of the present invention can be provided. A third button 106c can be located on the side of the grip 102 where it can be operated by, e.g., both the ring and pinky fingers.

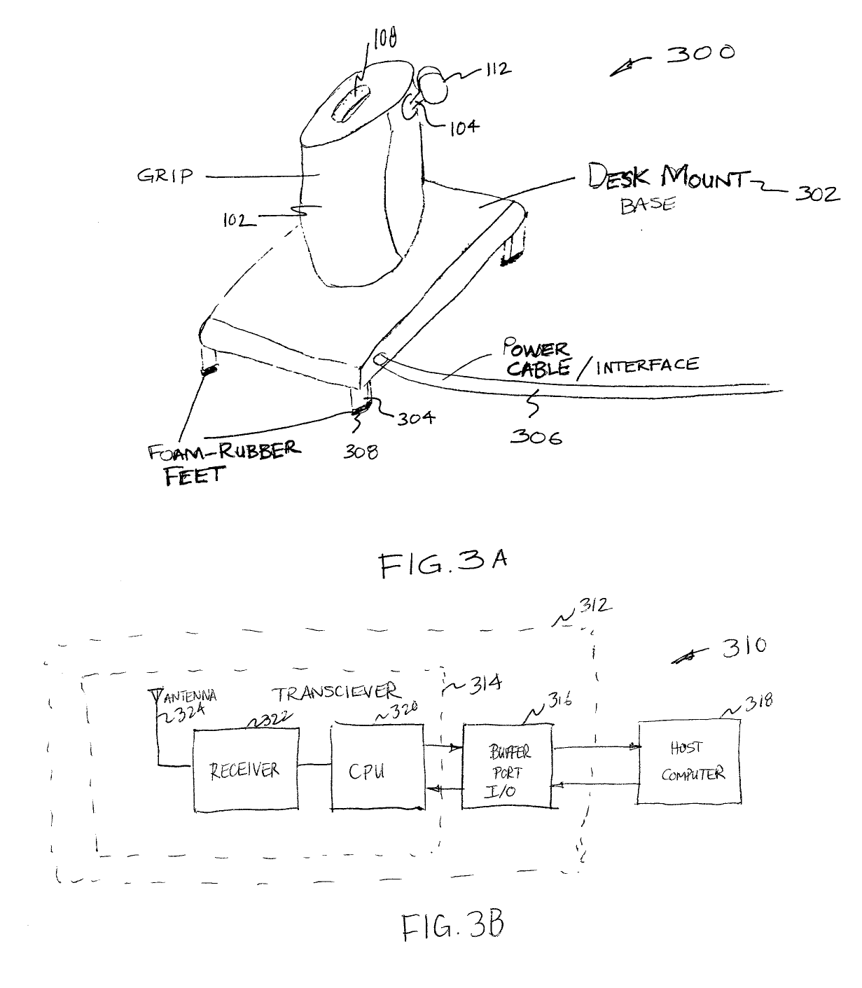

An exemplary embodiment of the invention can include wireless, cordless, or untethered operation. In an exemplary embodiment, a wireless transceiver (not shown) can be coupled to the grip portion 102 of the device 100. To power the device 100 in wireless mode, a rechargeable power supply can also be coupled to the grip 102. The bottom panel of the grip 102 can include connections 110 to couple the rechargeable power supply to a battery charging base 302 described further below with reference to FIG. 3. The pointing device in an exemplary embodiment can include a display that represents the level of power resident in a battery that can be part of device 100.

In a wireless embodiment of the device 100, the base 302 can include, e.g., a power supply to recharge the power source of the device 100 via the connections 110 on the bottom panel of the grip 102. Additionally, the base 302 of FIG. 3 can include a second wireless transceiver coupled in wireless communication to the first wireless transceiver located in the grip 102 of the device.

FIG. 1C depicts a left side view of the exemplary embodiment of FIG. 1A engaged by the hand of a user. A left-handed version could be provided as well. The hand of the user can comfortably surround the grip 102. The index finger of the user can engage the thimble-shaped housing device 112 of the finger-stick 104. The thumb of the user can also be positioned to operate the scroll wheel 108. The ring or pinky fingers of the user can be in position to comfortably operate the third button 106c of the device.

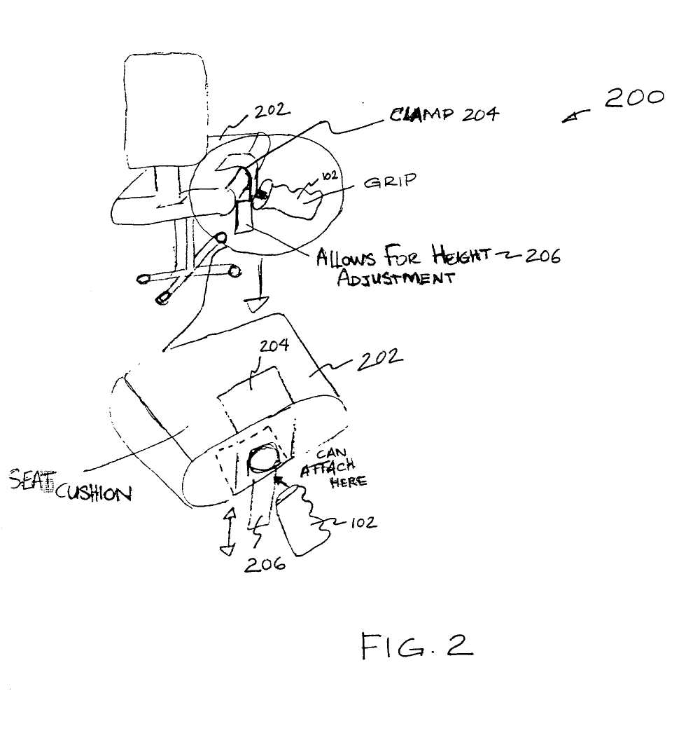

As shown in FIG. 2, the ergonomic positioning device can be attached to furniture such as, e.g., a chair to provide for more comfortable use. The user can operate the device with his arms at his side. A clamp 204 can be affixed to a seat cushion 202. The grip 102 of the device can be attached to the clamp 204. A slidable member 206 of the clamp 204 can allow the grip 102 of the device to be vertically adjusted for variance in user height and arm length. In addition to the chair depicted in FIG. 2, the clamp 204 shown can be adapted to be affixed to any piece of office or home furniture or any stationary object.

Examples of other pointing devices, whose features could be combined with the various exemplary embodiments of the pointing device of the present invention, include, e.g., Microsoft Mouse™ with scroll wheel available from Microsoft Corporation of Redmond, Wash., U.S.A.; and the IBM Trackpoint II™ pointing device available from IBM Corporation of Armonk, N.Y., U.S.A., Synaptics Touchpad™ available from Synaptics, Inc. of San Jose, Calif., U.S.A.; pen-based computers, and other mice and cordless or untethered mice such as, e.g., Logitech Cordless MouseMan® Wheel, WingMan® Force Feedback Mouse and Magellan SpaceMouse, available from Logitech of Fremont, Calif., U.S.A. In an exemplary embodiment of the present invention, pointing device 100 of the present invention can include features from other pointing devices such as, e.g., an Micro Stealth Wireless Windows 95 Keyboard With 14 Hot Buttons & I-Point Cursor available from Micro Innovations Inc. of U.S.A., an Acer 15201I Infrared Wireless Keyboard Model WIL-192U available from Acer Peripherals of Acer America, U.S.A., a Ackeytech ACK-240 Wireless Keyboard available from Ackeytech, U.S.A., a TView IR Wireless Keyboard with Integrated Mouse Function available from Focus Enhancements, U.S.A., a Gemini Industries Wireless MultiMedia IR Keyboard 104-KEY Windows 95 With 14 Hot Buttons available from Gemini Industries, U.S.A., a Yahoo! Freedom II 900 MHz Wireless Keyboard available iConcepts/Sakar Intl., U.S.A., a Versapoint Wireless Keyboard PS/2 With 50 ft Range available from Interlink Electronics, U.S.A., a Logitech 967018-0403 iTouch Cordless Keyboard available from Logitech, MaxInternet Wireless Remote Keyboard available from MaxInternet, U.S.A., a Liberator Wireless Keyboard 105-Key Infrared w/ Trackball available from Microspeed, U.S.A., a Mind Path Model WK86 Wireless Keyboard Windows available from Mind Path Technologies, U.S.A., a Surfboard Remote Win95 Wireless Keyboard available from PC Concepts, U.S.A., a Proxima Wireless Keyboard for all Proxima Projectors available from Proxima, U.S.A., a Spec Research Dyna Point Model KB9820 Wireless Keyboard available from Spec Research, U.S.A., a Model KI-W250 WebTV Wireless Internet Keyboard available from Microsoft Corporation of Redmond, Wash., U.S.A., and other wireless devices, pointing devices, and keyboards many of which can be ordered from, e.g., http://www.wirelesskeyboards.net. For further information relating to useful features that could be combined with the exemplary embodiments of the present invention, the reader is directed to U.S. Pat. No. 5,828,365 to Chen, for an “Electric Field-Induced Cordless Mouse Device,” filed Nov. 29, 1996, U.S. Pat. No. 5,808,568 to Wu, for a “Finger Operated Module for Generating Encoding Signals,” filed Mar. 25, 1997, U.S. Pat. No. 5,706,026 to Kent et al., for a “Finger Operated Digital Input Device,” filed Jan. 6, 1998, U.S. Pat. No. 5,982,356 to Akiyama, for an “Ergonomic Computer Cursor Control Apparatus and Mount,” filed Oct. 15, 1997, U.S. Pat. No. 5,764,224 to Lilja et al., for a “Cordless Mouse-Stylus-Pointer,” filed Mar. 25, 1997, U.S. Pat. No. 5,930,368 to Hocker et al., for a “Docking Method for Establishing Secure Wireless Connection Between Computer Devices,” filed Apr. 10, 1997, U.S. Pat. No. 5,912,661 to Siddiqui, for a “Z-Encoder Mechanism,” filed Jun. 15, 1999, U.S. Pat. No. 5,806,849 to Rutkowski, for a “Electronic Game System With Wireless Controller,” filed Nov. 29, 1996, U.S. Pat. No. 5,09,302 to McLean et al., for a “Three Dimensional Mouse Via Finger Ring or Cavity,” filed Jun. 19, 1989, U.S. Pat. No. 5,668,574 to Jarlance-Huang, for a “Palm-Top Wireless Trackball,” filed Jun. 25, 1995, U.S. Pat. No. 5,774,113 to Barnes, for a “3-D Mouse on a Pedestal,” filed Mar. 6, 1995, U.S. Pat. No. 5,894,303 to Barr, for a “Computer Mouse and Shell Therefore,” filed Apr. 28, 1997, U.S. Pat. No. 5,355,147 to Lear, for an “Ergonomic Computer Mouse,” filed Oct. 11, 1994, U.S. Pat. No. 5,973,673 to Hodson, for a “Cursor Control Device,” filed Oct. 26, 1999, U.S. Pat. No. 5,729,220 to Russell, for an “Ergonomic Customizable User/Computer Interface Device,” filed Mar. 17, 1998, the contents of which are incorporated herein by reference in their entireties.

FIG. 3A depicts an exemplary embodiment of the ergonomic pointing device 100 coupled to an exemplary desk mounted base 302. The base 302 can include legs 304. The legs 304 can include foam rubber feet 308, e.g., at each corner. Extending from the desk mount can be a power cable or interface 306. The interface 306 can couple the desk mounted base to any number of interfaces including, e.g., a serial interface, an RS/232 asynchronous interface, a PS/2 mouse interface, a PC/AT mouse interface, a universal serial bus USB interface, a USB2 interface, a firewire interface, or other interface as will be apparent to those skilled in the relevant art. An additional feature can allow the interface to be coupled to the grip portion 102 of the device 100.

FIG. 3B depicts a block diagram 310 of an exemplary embodiment of a control module 312 of a base 302. Control module 312 can include, e.g., transceiver 314, and an input output port and buffer 316 coupling the transceiver 314 to a host computer 318. Transceiver 314 can include, e.g., a CPU and memory 320, a receiver 322, and an antenna 324.

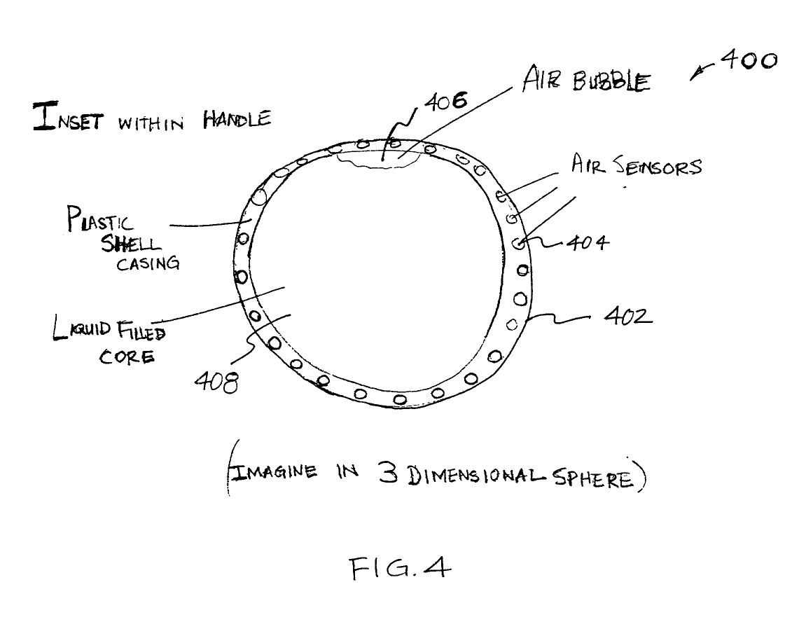

An additional feature of the invention can include, e.g., an orientation sensor operative to determine the orientation of the pointing device 100. As shown in an exemplary embodiment in FIG. 4, an exemplary orientation sensor 400 can include a sphere 400 having a core 408 which can be substantially filled with liquid. An air pocket 406 can be located within the liquid and can always float to the true top of the sphere regardless of the device orientation. The sphere can be formed by a plastic shell casing 402. About the plastic shell casing 402, air sensors 404 can be spherically arranged operative to determine the location of the air pocket 402. Upon detection of the air bubble 406, the sensors 404 can feed the information to a processing unit which can calculate and adjust both the X and Y axes based on the “true up” positioning of device 100.

In another exemplary embodiment, pointing device driver software can include an option to swap X-axis and Y-axis allowing left and right movement of the pointing device to register up and down cursor movement and vice versa. As will be apparent to those skilled in the art, the axis toggling feature can also be used with other conventional pointing devices.

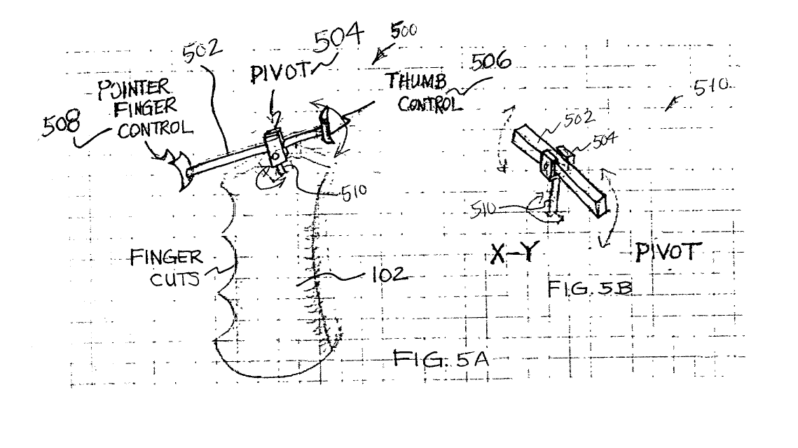

A further exemplary embodiment is depicted by FIG. 5A. FIG. 5A shows a finger and thumb control stick 502 attached to grip 102. The control stick 502 can pivot about a pivot point 504 close to the midpoint of the control stick 502. The control stick 502 can include a finger control 508 on one end and a thumb control 506 on the other. The control stick 502 can pivot and rotate about a vertical axis 510 such that the opposing finger control 508 and thumb control 506 can be manipulated in both the x and y dimensions. This finger control system can be controlled individually by the index finger or thumb or both. FIG. 5B illustrates in greater detail the exemplary embodiment of FIG. 5A.

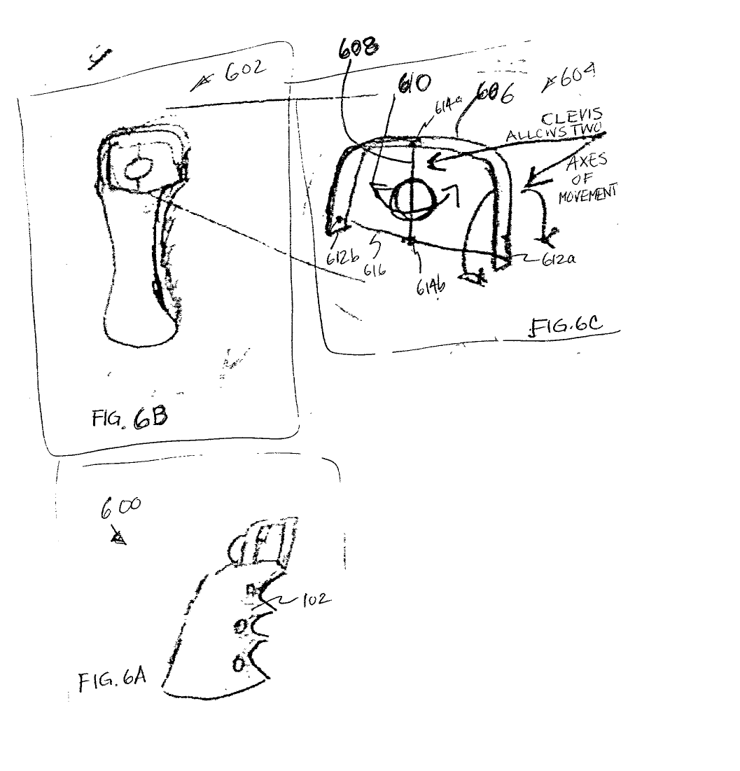

FIG. 6A shows a side view 600 of another exemplary embodiment of the finger stick of the present invention. FIG. 6B depicts a back view 602 of the device with the sphere and U-shaped member. FIG. 6C shows an enlarged view 604 of the sphere and U-shaped apparatus of FIGS. 6A and 6B. A first member 608 axially intersects a rotatable sphere 610. The first member 608 is coupled at one end 614a symmetrically to an inverted U-shaped clevis member 606 and at another end 614b to the device grip 102. The U-shaped clevis member 606 and ball 610 apparatus can be attached to the top panel of the device grip at points 612a and 612b. Pressure can be applied to the sphere 610 and can rotate the sphere 610 about its vertical axis rotating first member 108 to operate to displace the cursor in the x-dimension. An additional feature can allow displacement of the sphere 610 to be opposed by means of a bias or spring force. The spring force can act on the sphere 610 to return it to its original position after displacement. The U-shaped clevis member 606 can be pivoted about an axis 616 at points 612a and 612b to displace the cursor in the y-dimension. In one exemplary embodiment the sphere can include, e.g., indentations for ease of user comfort. As will be apparent to those skilled in the relevant art, other three dimensional shaped objects can be used alternatively to a sphere, such as, e.g., a cylinder, a cube, or any other shaped object graspable by a user.

While the invention is described in some detail with specific references to exemplary embodiments, those skilled in the art will appreciate that the ergonomic positioning device may be used for any number of devices and applications, including a computing device, a gaming device, an Internet appliance, a projector, audio/visual equipment, a virtual reality software application, a software application, a software application game, and a television device.

In the present invention, the use of the word “finger” can be used to refer to a finger or a thumb. Thus when the term “finger-stick” is used, it can be equally used by a thumb or finger.

While various embodiments of the present invention have been described above, it should be understood that they have been presented by way of example only, and not limitation. Thus, the breadth and scope of the present invention should not be limited by any of the abovedescribed exemplary embodiments, but should be defined only in accordance with the following claims and their equivalents.

What is claimed is:

1. An ergonomic pointing device comprising:
a grip portion configured for handheld use;
a finger-stick coupled to said grip portion, operative to control a cursor pointer; and
a first button disposed on said grip portion operative to receive a user selection.

2. The pointing device according to claim 1, further comprising:
a first wireless transceiver coupled to said grip portion; and
a rechargeable power supply coupled to said grip portion.

3. The pointing device according to claim 1, wherein said finger-stick is operative as a joystick.

4. The pointing device according to claim 2, wherein said first wireless transceiver includes at least one of:
a radio frequency RF wireless transceiver;
an infrared IR wireless transceiver;
a laser transceiver; and
a microwave transceiver.

5. The pointing device according to claim 1, wherein the device is operative to control a cursor of at least one of:
a computing device,
a gaming device,
an Internet appliance,
a projector,
audio/visual equipment,
a virtual reality software application,
a software application,
a software application game, and
a television device.

6. The device according to claim 1, further comprising:
a second button operative for user selection by the ring and pinky fingers of the user.

7. The device according to claim 1, further comprising:
a clamp configured to receive the pointing device and configured to attach to at least one of:
a chair;
office furniture;
a stationary object;
furniture; and
home furniture.

8. The device according to claim 1, further comprising:
a scroll wheel disposed on said grip portion.

9. The device according to claim 8, wherein said scroll wheel can be used to page up and page down through a displayed screen of text.

10. The device according to claim 8, wherein said scroll wheel is operative at least one of:
to control said cursor pointer; and
to manipulate, in a z-direction, 3-D applications.

11. The device according to claim 1, further comprising:
an orientation sensor operative to determine an orientation of the pointing device.

12. The device according to claim 11, wherein said orientation sensor includes a sphere having a core substantially filled with a liquid, an air pocket, and spherically arranged sensors operative to determine a location of the air pocket to determine orientation.

13. The device according to claim 2, further comprising:
a base operative to recharge said rechargeable power supply;
a second wireless transceiver coupled to said base in wireless communication with
said first wireless transceiver;
a power supply coupled to said base; and
an interface coupled to said base.

14. The device according to claim 13, wherein said interface is at least one of:
a serial interface,
an RS/232 asynchronous interface,
a PS/2 mouse interface,
a PC/AT mouse interface,
a universal serial bus USB interface,
a USB2 interface, and
a firewire interface.

15. The device according to claim 1, further comprising:
an interface coupled to said grip portion.

16. The device according to claim 15, wherein said interface is at least one of:
a serial interface,
an RS/232 asynchronous interface,
a PS/2 mouse interface,
a PC/AT mouse interface,
a universal serial bus USB interface,
a USB2 interface, and
a firewire interface.

17. The device according to claim 13, further comprising:
a computer system coupled to said base by said interface.

18. The device according to claim 1, wherein said finger-stick comprises a finger-stick control module including a quad matrix of variable resistors, wherein each variable resistor of said quad matrix of variable resistors varies in conductivity, directly in proportion with a static position of said finger-stick control, wherein a first two of said quad matrix of variable resistors are provided for an x-axis of motion to account for positive and negative movement, and wherein a second two of said quad matrix of variable resistors are provided for a y-axis of motion to account for positive and negative movement.

19. The device of claim 18, wherein said each variable resistor of said quad matrix of variable resistors comprises an interlocking grid of conductor traces over which a rubber carbon compound can be placed, wherein increased pressure on said rubber compound increases circuit conductivity.

20. The device according to claim 6, further comprising:
an analog to digital converter coupled to said first and second buttons and said
finger-stick and operative to translate directional movement and receiver selections of said first and second buttons into digital code.

21. The device according to claim 6, further comprising:
a central processing unit CPU coupled to said analog to digital converter ADC and
operative to organize and add protocol to said digital code.

22. The device according to claim 1, wherein said finger-stick has a thimble-shaped housing disposed on said finger-stick;

23. An apparatus operative to receive a rechargeable wireless pointing device comprising:
a base operative to recharge a rechargeable power supply of the pointing device;
a second wireless transceiver coupled to said base in wireless communication with
a first wireless transceiver of the pointing device;
a power supply coupled to said base; and
an interface coupled to said base.

24. The device according to claim 1, wherein said finger stick comprises:
a first member axially intersecting a rotable sphere, said first member coupled at one end symmetrically to an inverted U-shaped clevis member, and at another end to the grip, and wherein
said u-shaped clevis can rotate about an axis intersecting end points of said U-shaped clevis.

25. The device according to claim 1, wherein said finger-stick comprises a vertical member, a pivot, and a horizontal member coupled at an inner point to said pivot, and including controls at ends of said horizontal member.
